(19) United States
(12) Patent Application Publication
(10) Pub. No.: US 2011/0156494 A1
(43) Pub. Date: Jun. 30, 2011

(54) Wireless Energy Transfer System

(75) Inventor: Alex Mashinsky, Memphis, TN (US)

(73) Assignee: Governing Dynamics LLC, New York, NY (US)

(21) Appl. No.: 13/060,831

(22) PCT Filed: Aug. 25, 2009
(86) PCT No.: PCT/US09/04858

§ 371 Date: Feb. 25, 2011

Related U.S. Application Data
(60) Provisional application No. 61/091,460, filed on Aug. 25, 2008.

(51) Int. Cl. H02J 17/00

(52) U.S. Cl. 307/104

(57) ABSTRACT

A system for transmitting power without wires or with no more than one connection, wherein communication is provided between an unlimited number of electronic devices, or to connect these devices to an unlimited number networks that are located externally to the system to thereby enable high speed voice and data communications over a single resonant connection At least one transmitter and one receiver are utilized, which may have the same or different configurations, such that an induced oscillating electπc current, which occurs at the resonant frequency of a transmitter, induces a standing wave The standing wave is tuned and “tapped” by a receiver having a coil or set of plates and receivers that are tuned to oscillate at the same frequency or one of its harmonics and, thus, absorb an electrical current and/or signals at the receiver

### CROSS-REFERENCE TO RELATED APPLICATIONS

This application claims priority from U.S. Provisional Application Ser. No. 61/091,460 filed Aug. 25, 2008, the content of which is hereby incorporated by reference in its entirety.

### BACKGROUND OF THE INVENTION

1. Field of the Invention

The present invention relates to the field of power and data distribution and, more particularly, to a method and system for efficient transmission of power and signals using wireless communication devices.

2. Description of the Related Art

Currently, almost all power transmission that occurs operates on a closed circuit where power is generated in a generation facility, carried over wires and is then, with the use of step down transformers, delivered via closed circuit load or motor to an end user. Some systems use a single wire delivery system in which the earth is used as a return, but the generation and delivery system is the same as the previously described system. Such known system are built to support hundreds and in a few cases up to 2000 miles of distance. The loss factor in most of these systems, which are known as long-haul systems, is 7-10%, and they cost hundreds of millions of dollars to produce.

While some attempts to use other forms of transmission in wired and wireless forms have been tried, there is no system that has been proven to scale or cover great distances or that supports millions of users and billions of devices which could be connected to such architecture.

There are multiple known methods of wireless energy transfer. One such technique is known as “radiative” energy transfer, which entails generating an electromagnetic field. Here, a special receiver acquires electromagnetic radiation that has not naturally dissipated in the air and converts the acquired electromagnetic radiation into electricity. The energy associated with the electromagnetic radiation can travel nearly three meters (approximately ten feet) to thereby keep a small battery charged. However, most of the energy associated with the electromagnetic radiation is lost before reaching the receiver and the power that does reach the receiver is extremely low. Nevertheless, such a technology, which has been pioneered by Powercast in Philadelphia, Pa., was deployed for the first time in 2008 by Philips in a small power application, such as lights on Christmas decorations.

Another known technique also relies on magnetic fields. However, this technique is still in the experimental stage, and operates based on principles of resonance. When two objects resonate at the same frequency, they transfer energy efficiently in much the same manner as a child that easily maintains momentum on a swing when he or she uses his or her legs to move in synchronization with the rhythm of the swing while it is in motion. The use of magnetic resonance allows the transfer of energy in useful quantities and almost entirely to the receiving device. However, as in the radiative method, the energy can travel only a distance of a few meters. Nevertheless, ever since its inventor, Marin Soljacic of MIT, presented his work at a conference in the autumn of 2008, he has continually but unsuccessfully tried to increase the effective distance beyond several feet. The technology pioneered by Martin loses more than 60% of the transmitted power at a distance greater than 6 feet.

“Inductive coupling” is another way of transferring energy. Here, power or energy transfer in inductive coupling is not so much wireless as it is plugless or socketless. That is, power is sent on almost direct contact, for example, with a mat upon which gadgets can be placed to recharge. The method avoids the need for cables and connectors to charge gadgets, and can be built into many surfaces, such as car dashboards or office furniture. This system, with a few variations, is employed by start-ups such as Splashpower in Britain, WildCharge and Fulton Innovation in America.

Instead of transferring power wirelessly, it may be worthwhile to transport fuel, such as coal, oil or hydrogen, in a conventional manner. It is clear that the cost of transporting fuel has increased drastically in recent years and, as such, it has become much more expensive to produce electricity with all variety of traditional transmission means. There are significant drawbacks to this method of energy supply. First of all, it requires an enormous amount of energy, transportation vehicles, and human labor. These requirements drive up the cost of the portable energy source. In addition, these energy sources often are hazardous; hydrogen, for example, ignites with ease. Also, the burning of many types of fuels pollutes the environment.

Another option is to utilize a local power source, such as solar or wind power. However, the number of locations that are suitable for solar or wind power stations is limited. A particular climate is required, such as that of the Sahara desert for solar power and Texas, United States for wind power. There are many additional drawbacks to these power sources. The current technology for converting solar power into electrical power, photovoltaic cells, is extremely inefficient. Solar power is at this time unable to quench the world's demand for energy due to its inefficiency. One method of utilizing wind power is the installation of huge turbines in a consistently windy region. However, these installations demand open lands prone to consistent, strong wind currents; in other words, they are not generally placed in communities. Thus, the wind power must be transported; this is usually performed by power lines.

There are many methods of voice and data communication, including the Internet, the phone lines, the radio broadcast system and mobile cell phones. These systems either utilize transmission lines of some sort, or they use electromagnetic radiation. Transmission lines have a high initial cost and an upkeep cost. Electromagnetic radiation is an inefficient method of transfer since its power loss is proportional to the square of the distance from the emitting source. In addition, electromagnetic radiation has a potentially harmful effect on humans and other life forms.

It is therefore apparent there is a need for a wireless transmission system for voice, data and power.

### SUMMARY OF THE INVENTION

Disclosed is a system for transmitting power, voice and data without wires or with no more than one connection. The system is configured to provide communication between unlimited numbers of electronic devices, or to connect these devices to an unlimited number of outside networks that are located externally to the disclosed system to thereby enable high-speed voice and data communications over a single resonant connection. The disclosed system utilizes at least one transmitter and one receiver, which may have the same or different configurations, such that an induced oscillating electric current, which occurs at the resonant frequency of a transmitter connected to Earth or a physical body, such as a lake or plane or other body with defined parameters, can resonate with one or multiple devices tuned to the same frequency.

By modifying or tuning the natural frequency of a transceiver, it becomes possible to transmit over a single frequency or a multitude of frequencies and also receive over the same or different frequencies. Such frequencies (pulse modulated) are overlaid on top of power transmission or a signal which may exist between two or more resonant transceivers and can be inserted or extracted via conductors, induction, or other similar known methods of frequency or optical modulation.

The Earth is constantly showered with charged particles from the Sun and other stars which create electrostatic pressure on the ionosphere. This charge, which is insulated by the atmosphere, attracts the electrostatic potential in the Earth, and creates a high concentration of positive charge on the surface of the Earth. Moreover, the Earth is a giant dielectric with a very high potential energy and although not felt during daily life due to the even distribution of the potential on all parts of the Earth, it is possible to clearly see the effect of this potential energy during lightening and other types of electrical storms. The disclosed system advantageously uses the high potential and high charge of the Earth to induce scalar waves at an optimal resonant frequency and create a standing wave which can be used as a giant capacitor to absorb energy from generating facilities all over the world during low usage periods and to redistribute the generated energy to distribution grids during peak demand periods. When the wave is being charged with an increased electrostatic standing wave, the resonance is used to increase the amplitude of the wave and to absorb the generated energy, which is then recovered at a later time and used at any location of the planet.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic block diagram illustrating the general configuration of the system in accordance with the invention;

FIG. 2 is a schematic block diagram illustrating the components of a transmitter/receiver configured to transmit and operate a standing wave and receive data communications;

FIG. 3 is a schematic block diagram of a receiver configured in accordance with the invention;

FIG. 4 is an exemplary schematic block diagram for connecting existing voice, data, Internet and other networks to the system of FIG. 1;

FIG. 5 is an exemplary schematic block diagram illustrating a receiver providing its exact location in the system of FIG. 1;

FIG. 6 is an exemplary schematic block diagram of the exchange of power between a transmitter and receiver set in a car;

FIG. 7 is an illustration of graphical plots of exemplary signals provided during the exchange of power that occurs in FIG. 6; and

FIG. 8 is an exemplary schematic block diagram of a receiver which operates based on interference to communicate with a transmitter or other resonating elements in a network.

### DETAILED DESCRIPTION OF THE EXEMPLARY EMBODIMENTS

Disclosed is a system for transmitting power, voice and data without wires or with no more than one connection. The system is also configured to provide communication between an unlimited number of electronic devices, or to connect these devices to an unlimited number of networks that are located externally to the system to thereby enable high speed voice and data communications over a single resonant connection. The disclosed system utilizes at least one transmitter and one receiver, which may have the same or different configurations, such that an induced oscillating electric current which occurs at the resonant frequency of a transmitter connected to Earth or a physical body, such as a lake or plane or other body with defined parameters, can resonate with one or multiple devices tuned to the same frequency.

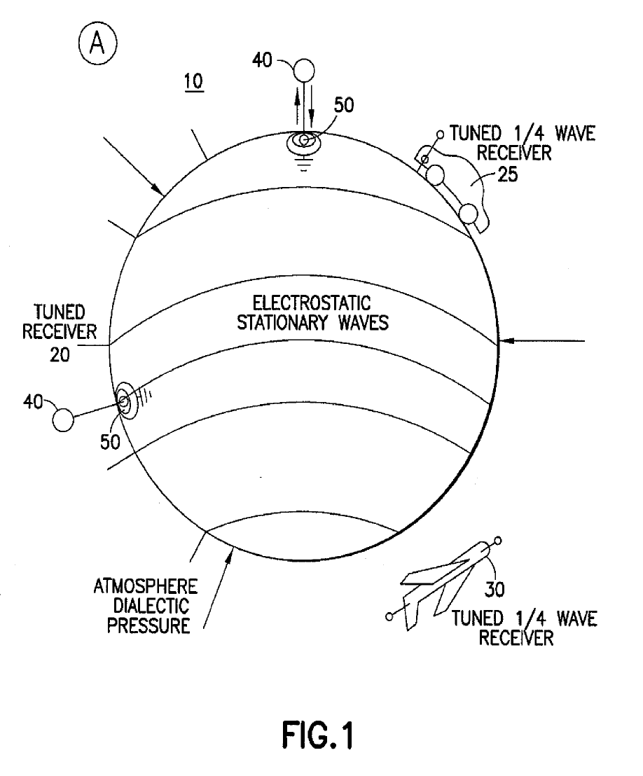

FIG. 1 is a schematic block diagram illustrating the general configuration of the system in accordance with the invention. With reference to FIG. 1, a transmitter node 10 is provided with an elevated capacitance of an Earth borne ground plane. By applying a high voltage to a set of coils at the transmitter node 10, an electrical charge is moved in rapid charge and discharge motions between the capacitor and the surface of the Earth. As a result, “sharp” electrostatic waves are created which traverse through the surface of the earth. These electrostatic waves are kept at the surface of the Earth by the insulating properties of the atmosphere, which acts as a high capacity dielectric, and close to the surface by the positive charge which exists outside the ionosphere due to the constant flow of positive particles bombarding the Earth from the sun and other stars. Any device, such as a “tuned receiver 20”, a car 25 or an airplane 30, which each have a tuned circuit that operates in resonance with the transmitter 10, will be able to absorb the electrostatic energy generated at point (a) and convert this energy into a standard electrical charge which can be used to charge a battery or power a motor. The power can be absorbed at different levels based on whether the receivers are stationary or in motion, well grounded or elevated and in phase or out of phase with the stationary wave.

Unlike a radio transmitter and receiver, the transmission without wires that is implemented in the disclosed system of FIG. 1 does not utilize electromagnetic radiation in which the electric and magnetic fields are transverse to the radiation propagation direction. That is, the system utilizes a phenomenon which can create a low energy standing electromagnetic wave that oscillates on a permanent basis at an exact frequency and wavelength, once the electromagnetic wave is established. Such a standing wave needs to be tuned, such that as the wave bounces back and forth between the point of origin and an anti-node, each discharge of the transmitter increases or at least maintains the charge level that was established in previous pulses or reflections. As long as the resonance is synchronized with the body, e.g., the lake or plane or other body with defined parameters, the system is configured such that the oscillating standing wave can be tapped by any receiver at quarter wave points and the charged energy can be discharged with less than a 5% signal loss. Such “resonating” longitudinal waves or standing waves are generated in nature each time lighting strikes the earth.

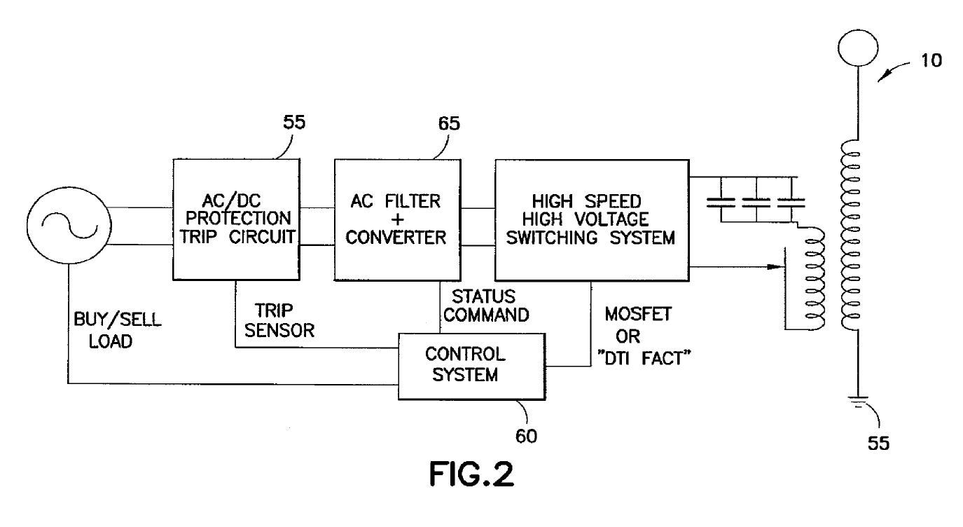

FIG. 2 is a schematic block diagram illustrating the components of a transmitter/receiver configured to transmit and maintain a standing wave and receive data communications. More particularly, FIG. 2 illustrates the elements/components used to construct the transmitter for generating and maintaining a standing wave that also serves as a transceiver for data communications. The elements include AC or DC trip circuit 55 and measuring devices which are connected to the control system 60. Any feedback loop or overload on the system will trip or break the connection to protect the power generation facility. An AC filter and converter 65 is used to condition and convert the power from a low frequency low input voltage to high frequency high voltage components. The system can utilize Tesla coils or solid state elements to achieve hundreds of millions of volts and at a frequency of at least 2 khz for a specific combination that will provide an optimum fit for the power or data application to be used. A switching system 70 is employed to charge and discharge the circuits in synchrony with the standing wave or communication signal to be created so that each discharge amplifies the traversing electric signal in synch and in resonance. MOSFETs or other solid state semiconductors, high voltage capacitors and coils can be used to provide a precisely tuned resonating circuit from components provided by companies such as WiTricity and Showa Aircraft in a manner which is known.

U.S. Pat. No. 645,576 to Tesla describes a system for transmitting electrical energy. According to Tesla, if a system is designed and tuned properly, the transmission utilizes non-Hertzian waves (i.e. waves having non-electromagnetic properties). These waves are conventionally known as scalar waves. Traditional data networks, such as the Internet, wireless networks, TV and satellite networks, can be carried over such connections that are established between the receivers and transmitter by adding and measuring interference or oscillations in the existing resonating standing wave. Even the slightest interference or electrical influence on the receiver or transmitter of a set of resonating circuits can be instantly sensed and measured, and can be used by high speed communication devices to form and maintain a two way communications infrastructure between all such resonating points. These signals can be connected via conductors or induction to traditional devices or networks for the transmission of voice, data and power or a combination of voice, data and power over long distances. Unlike conventional systems, which can only cover a radius of up to 100 miles, such a resonant system, if set up to operate on a global scale, can enable one transmitter to send electrical power, data and instant location and event information to every point on the planet and in the atmosphere. The disclosed system of the invention is not limited to transmission between one transmitter and one receiver. That is, one transmitter can transmit to one or multiple receivers, and multiple transmitters can transmit to one or multiple receivers. Here, the transmission is based on the frequency and resonance selected for each network which can be tuned and changed dynamically by modifying the capacitance and oscillations at the receiver.

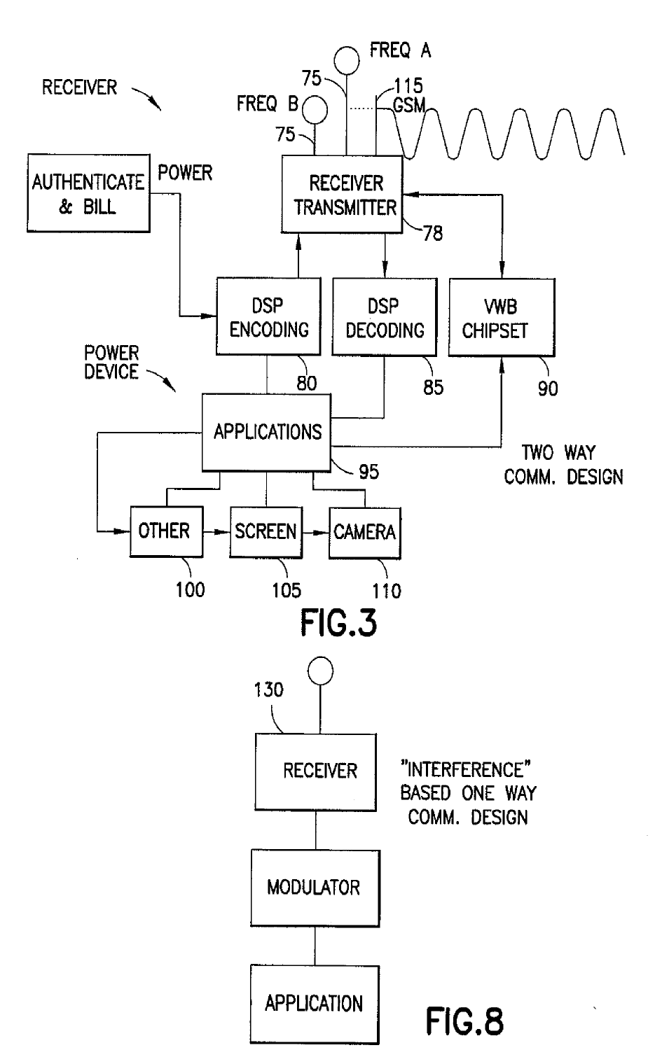

FIG. 3 is a schematic block diagram of a receiver configured in accordance with the invention and having the receiver components that are necessary to obtain the power or signals from the transmitter. Aerial capacitors and coils 75 connected to “Freq A” and “Freq B” elements are tuned to one or multiple transmitting towers 10 (see FIG. 1) and may be tuned dynamically by the device containing the receiver components shown in FIG. 3. The components are connected to a transceiver 78 which can detect and optimize the resonance levels, absorb the electrostatic charge from the standing wave and, via primary and secondary coils (in the manner described by Tesla), convert the electrostatic charge to a lower voltage AC power. This power source is conditioned, filtered and used to power the device or is returned to the local power grid. In addition, a UWB chipset or DSP based devices 80, 85, 90 are used to encode and decode communications over the established resonating circuit between the transmitter and receiver or the other resonating receivers on the same “channel”. Applications such as video or voice running on TCP/IP can then communicate with other devices 100, 105, 110 in much the same way as they currently communicate with the Internet or WiFi networks. In addition, the receivers may function as local gateways and be used as transceivers to send and receive communications from the resonating devices and a local network by bridging the communications with a conventional GSM transceiver 115.

It is also possible for multiple energized receivers to communicate or transmit to each other, because each receiver will provide a unique interference to the resonance which can be pinpointed to a specific device and its location on the planet. Accordingly, a large computer system located at the transmitter, which is also connected to all different, traditional networks can translate and traverse the signals between the networks.

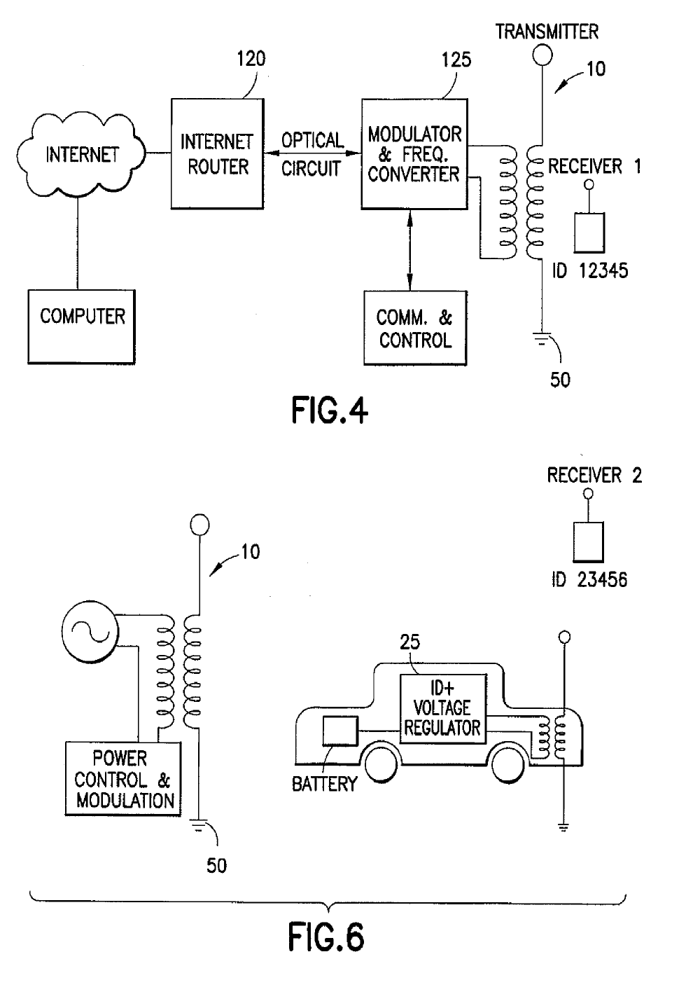

FIG. 4 is an exemplary schematic block diagram for connecting existing voice, data, Internet and other networks to the system of FIG. 1. An optical circuit connected to an Internet router 120 is connected to a modulation frequency combiner 125 which is used to overlay the electrical signal sent on the standing wave with a “broadcast” of 0 & 1 signals, which represent multiple streams of communications requests or sessions occurring between different Internet devices and devices on the resonant network. All resonant devices can receive the signal and process the “noise” to extract relevant sessions. The response can be interference or a set of transmissions over the same set of resonant signals. As shown in FIG. 4, each signal and interference has its own signature, such as ID 12345 or ID 23456. Consequently, each transceiver can detect and separate the sources to process them in parallel. Each receiver has its own internal ID (i.e., the exemplary ID 12345 or ID 23456) and signature in addition to its location which allows the transmitter to keep track of energy and communication use and provide system security.

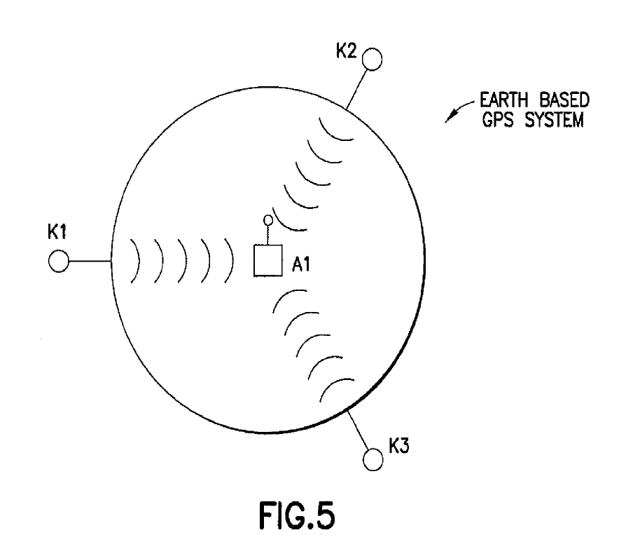

FIG. 5 is an exemplary schematic block diagram illustrating a receiver providing its exact location in the system of FIG. 1. The signal level and propagation delay are measured and calculated from at least two standing waves that originated from points K1, K2, K3. The location of these points is known to the receiver A1 and, therefore, the constant pulsing signal and its standing wave propagation delay can be easily measured. This information permits a quick calculation which reveals the location of A1. Moreover, each transmitter generates a wave which has a specific length. Accordingly, the measurement of the strength of the transmitted signal can indicate the distance of the top of the wave received at A1 and how many cycles occurred from the tower to A1.

By measuring each interference or transmission and measuring the location of the transmission, the computer system can send or receive specific information corresponding to a specific channel of communications between a specific user or computer accessing the Internet, as well as a specific user located on the resonant network who may be using a device powered by the resonant power transmitter that is located thousands of miles away from a tower that is transmitting power. By relaying messages between the two sources, a transparent communication can be maintained at very high speeds. Here, the receiver or receivers are required to resonate at the natural frequency of the transmitter or transmitters to establish data or power transmission. For optimal results, the resonance needs to include the body, e.g., the lake or plane or other body with defined parameters connecting the receiver and transmitter. The speed of light is divided by the selected frequency multiplied by a predetermined number, such as 4, in order to calculate the wave pattern. Consequently, when a transmitter and receiver are set up at different points on the Earth, the stationary wave will oscillate every 2.3 miles. Preferably, the selected frequency is between 1-20 khz.

In accordance with the invention, the receiving tower is built at a point at which the quarter wave will peak such that a maximum level of energy is absorbed by the receiver. For communications and mobile power applications, the amount of power that can be absorbed will vary based on the distance from the tower and the frequency used by the transmitting tower. In an embodiment, multiple transmitting towers having different frequencies and locations are used and multiple receivers are placed in devices, such as electric cars and airplanes, to ensure that at any location sufficient power can be absorbed to continue the operation of devices or systems. In accordance with the contemplated embodiments, the configuration of the transmitter is substantially identical to the configuration of the receiver, except for the reverse direction of their respective coils. Consequently, it is possible to power a receiver to transmit power or data to its respective transmitter, now acting as a receiver. Within the context and scope of the invention, it should be noted that the transmitting or receiving apparatus described by Tesla is a transceiver, where the system can be configured to transmit one-to-one, one-to-many or many-to-many.

By modifying or tuning the natural frequency of the transceiver, the transceiver may transmit over a single frequency or a multitude of frequencies and may also receive over the same or different frequencies. Such frequencies (pulse modulated) are overlaid on top of the power transmission or signal which may exist between two or more resonant transceivers and can be inserted or extracted via conductors, induction, or other similar known methods of frequency or optical modulation.

By oscillating high voltage currents between an elevated insulated terminal (i.e., transmitter node 10) and the surface of the Earth using a Tesla coil or other high voltage MOSFET and capacitor configuration, a pumping effect is thus created which, at the right frequency and discharge pattern, can perfectly resonate with the earth and its existing electrical charge to create and maintain a standing wave which can be tuned and “tapped” by a receiver having a coil or set of plates and receivers that are tuned to resonate and oscillate at the same frequency or one of its harmonics. As a result, it becomes possible to absorb an electrical current or create signals by tapping the power source at the receiver which can be instantaneously received or recognized on the transmitter side. Accordingly, power, data, or a combination of data and power is transferred with minimal energy loss to the receiver.

The disclosed system of FIG. 1 utilizes a tower 10 (i.e., an elevated insulated terminal or transmitter node) having multiple conducting windings, e.g., coils, comprising metals or superconductors. Here, the coils are tuned to resonate at a predefined frequency (or frequencies), and through induction transform an input voltage and signal to a desired level which is within authorized transmission levels in the country of operation. The transmitter obtains generated electrical power and increases the voltage and frequency of the obtained electrical power through a series of transformers and coils.

A large capacitive Tesla coil is used to create a very high electrostatic charge on a secondary coil which is connected to an elevated capacitance metal doughnut like structure 40 on one side and to a large metal plate 50 that is placed at depth in the ground on the other. Typical Tesla coil designs that are suitable for implementation in the disclosed system of the invention are described in U.S. Pat. Nos. 645,576; 725,605; and 1,119,732.

Preferably, the tower is at least 100 feet high and the plate is placed at a depth that is at least 60 feet deep into the ground. It should be appreciated that certain embodiments of the disclosed system will be based on the specific use of the power, signal levels, and the wave and frequency that is used to transmit the power. The elevated capacitance metal doughnut structure is provided with a maximized surface area to create the highest capacitance possible, and to match the charge and discharge cycle of the frequency used. In the preferred embodiment, the optimal charge and discharge cycle is 0.08484 of a second. The tower is used to enable and magnify free oscillations which are opposite to how traditional induction transformers use their metal core to direct and constrain oscillations within the windings. The elevated capacitance metal doughnut-like structure 40 and the coil windings need to have an optimal amount of insulation to ensure minimal or no leakage of electrostatic charge into the surrounding environment. Tesla coils are generally used to provide electrostatic discharges. For a standing wave to exist and be of useful purpose for power or data communication, however, it is critical that no Hertzian transmissions or aerial discharge occur. Consequently, the number of windings of each Tesla coil, the capacitors, the cycles used, the specific design type of the Tesla coil, the capacity and height of the elevated terminal and the pulse and discharge elements are considered and used to carefully tune the system to ensure that the oscillating standing wave can be sustained and managed. The upper capacitance element may be made of aluminum or copper. Preferably, the elevated capacitance metal doughnut-like structure 40 is provided with a large surface area and several layers of insulation. The charge provided by the tower oscillates at the preferred frequency which may be optimal for the application desired and the service provided. The oscillation creates standing waves in the electromagnetic charge on the surface of the Earth which propagates throughout the surface with very low resistance. A tuned receiver, resonant to the standing waves, receives the oscillating standing waves and translates them back into an electrostatic charge or signal on the secondary coil of the receiving circuit, i.e., the tuned receiver. The process is reversed to obtain an electrical charge on the primary circuit of the tuned receiver. The charge is then tuned for connection to a local grid or electrical lines for use in a normal environment. In accordance with the contemplated embodiment of the disclosed system, transmitting towers are placed adjacent to generating facilities and receiving towers are widely dispersed around the planet such that service is provided to a local area via a local power grid. It is also possible for cars and aircraft to tap into the same standing wave, because the amplitude of the wave is set by the transmitting tower to cover the service areas or flight routes of aircraft. Moreover, the shape of the standing wave is precisely controlled. As a result, the standing wave can be directed to follow along a specific flight path while not propagating or radiating outward in other unwanted directions.

FIG. 6 is an exemplary schematic block diagram of the exchange of power between a transmitter and receiver set in a car 25. A transmitter and receiver set in a car are configured to exchange power and are used to provide mobile power to allow cars all over the world to use small batteries and charge these batteries without wires and thereby obtain all the energy they need from a small set of transmitters that are widely disbursed around the world.

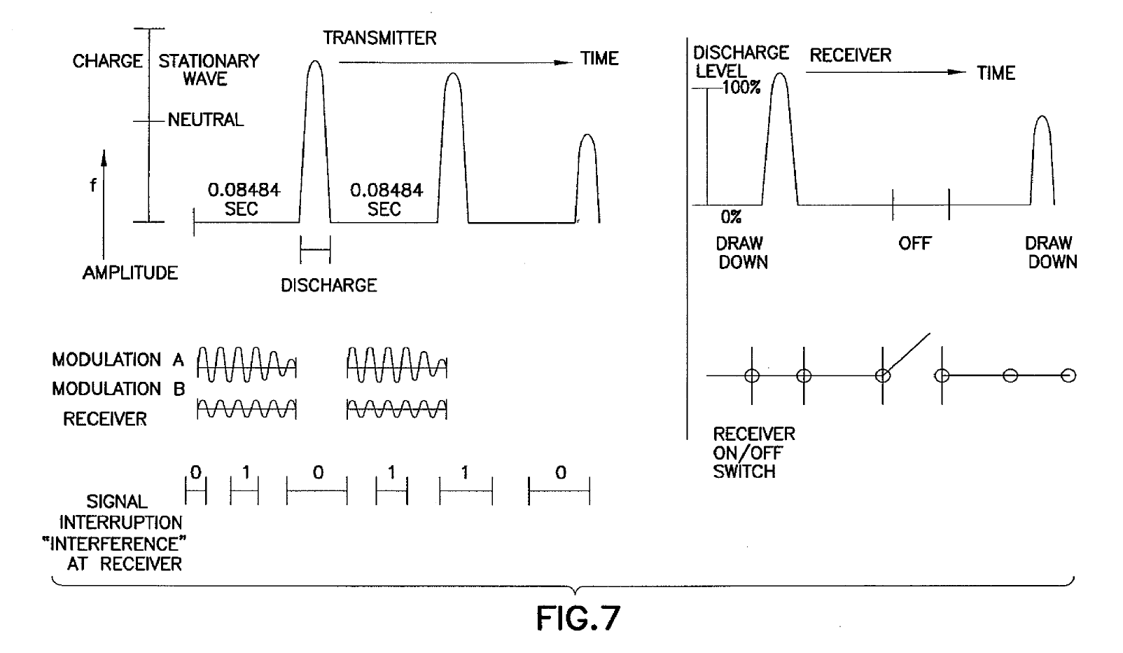

FIG. 7 is an illustration of graphical plots of exemplary signals provided during the exchange of power that occurs in FIG. 6. At a timer period, such as every 0.08484 seconds, a charge is generated by a Tesla coil, as shown in FIG. 7. The electrostatic charge builds up and charges the elevated capacitance, and a timed and controlled discharge occurs as a wave of electrostatic charge arrives at the transmitter from previous discharges. The discharge is required to occur at an exact moment in time so that the discharge is in synch with the standing wave and amplifies the effect of the standing wave. Here, the level and timing of the discharge can be used to correct the timing or shape of the standing wave, add to its electrostatic charge level, maintain the wave at a constant level or reduce its level. Moreover, different forms of modulations can be used in the intervals since all devices tuned to the same frequency which are in resonance can instantly detect the modulation. The timing diagram indicating the switching cycle of the receiver provides an illustration of the impact on the standing wave due to the connected or disconnected nature of the receiving side.

One reason for the low energy loss associated with the propagation of energy is due to the high charge and high pressure of the electrostatic charge on the surface of the Earth and the requirement for very little energy to create or propagate electromagnetic waves and to maintain them at a stationary level at the same amplitude. An analogy of the propagation of electromagnetic waves may be drawn between the motions of a ripple on the surface of a pool filed with water. In the case of such a water-filled pool, it takes very little energy to move the water on the surface of the pool and, at the right frequency, the energy will create very high waves and lots of power at the edge of the pool where the “standing wave” will hit against a solid surface. Bearing this in mind, in the system of the disclosed invention, the receiving tower is “hit” by standing waves, and unless the receiving tower absorbs the electrostatic energy of the standing waves, very little loss or power is needed at the transmitting tower to maintain the motion of the wave. Due to the elliptical surface of the Earth, it is possible to convert 97% of the energy of a standing wave while transmitting power to every point on the surface of the Earth.

A receiver tuned to resonate at a quarter, half, or the total resonating wavelength of the transmitter or one of its harmonics may receive both power and a modulated signal. Here, the receiver may use the power transmitted to decode the modulated signal and then process the information. The receiver can be programmed to automatically respond to the received signal (information) by creating interference or absorbing the generated power wave. Alternatively, the receiver can transmit a predefined response provided by an operator or user to a local network or other wireless standard, such as 3G or WiFi. Here, it is possible to continuously tune the transmitting frequency so that the transmission can be modulated using a variety of existing systems, such as those used in wireless, optical and data processing applications for radio broadcasts and for the Internet. In accordance with the disclosed embodiments, multiple transceivers are tuned to transmit and receive transmission at a chosen frequency. Consequently, a network is created in which all transceivers having the same resonance frequency can interact with all of the transceivers within the group. As a result, the transceivers enable each transceiver to detect the most minute changes or fluctuations of induction or interference which can be controlled and used for signaling or data transmission at the receiving or transmitting towers. It is contemplated that billions of these devices will operate in tandem, wherein each device has a unique interference pattern that distinguishes a specific device from all other devices resonant on the same network. It is also contemplated that multiple networks configured in accordance with the disclosed embodiments of the system will operate at different frequencies and different power levels, and at different levels of resonance, which may be harmonics of the original frequency produced by the transceiver for the transmission of power or data. Alternatively, by using at least two transmitting towers, the location of any receiver (i.e., a location provided by GPS) can be established based on a delayed resonance effect and the direction of the interference or signal disturbance. Consequently, an Earth-based GPS system provides tracking and location information as well as the identity of which communication stream belongs to which transmission stream. As a result, all devices or systems can concurrently communicate and “listen” to a relevant transmission while all other noise is ignored by all other devices or systems.

In accordance with the disclosed embodiments of the system, multiple transmitting towers additionally provide location information (i.e., from a ground based GPS service) based on the level of each wave that is received from each tower. Here, each wave has a predetermined frequency. It is thus relatively easy to detect which stage of the half wave the user is receiving. The receiving device is also configured to calculate the distance from the tower by measuring the number of cycles performed based on the Doppler effect or propagation delay in which the signal source is compared to an atomic clock or a message embedded in the signal sent from the tower. By collecting the signals from at least 2 towers, the exact location of the receiving device can be calculated. A GPS receiver is thereby provided which will not be blocked if placed inside a cave or a building. A receiver provided with GPS in accordance with the invention thus advantageously provides the ability to continually receive power transmissions in places where it was previously impossible to receive power signals.

Unlike conventional wireless and power transmission systems, a system in accordance with the contemplated embodiments is based on scalar wave technology and modulation, and operates at great distances with higher speeds and lower power requirements than Hertzian cellular systems or Hertzian broadcast systems. The disclosed systems also require much lower power and voltage levels for transmission, because only a small amount of the signal and power is lost, and any interference is sensed at the transmission side which also serves as a power source. In accordance with the disclosed embodiments, the total output or consumption of generated power at a central transceiver is substantially equal to the amount of power that is received, and is used to transmit back from all devices and systems that are tuned and resonating at the same frequency and modulation minus an approximately 2 to 5% power loss associated with resonance, interference and ground losses.

The contemplated embodiments of the system include a hub that operates and connects existing terrestrial power and data networks, as well as satellite and mobile systems, to a network of scalar wave based devices. Each transmission tower translates and modulates signals from devices tuned to resonate at the same frequency or combination of frequencies, and if operated at high voltages and high frequencies these device can be caused to couple so that any effect on the receiver can be instantly measured at the transmitter and vice versa.

The receiving towers of the disclosed system are configured to translate the received signals for connection to a cellular network, land lines, satellite, broadcast network or the Internet based on the device, the type of transmission and/or the application used by the device or its operator. The systems connected to the tower also translate the transmitted modulation from one network to the other to enable the data to reach an end device in use by an end user. For example, a fiber-based Dense Wavelength Division Multiplexing (DWDM) system operating at 1 Gbps may be connected to a router which is then connected to a high speed pulse modulator using Ultra Wide Band (UWB) chip sets and a signaling system operating at the same speed. The signal is then modulated on the scalar based transceiver and delivered without any loss or interference to the resonant oscillating coil embedded in the user device. The user device can then operate at the same speed as the fastest network backbone (e.g., 3G and WiFi) and retransmit any signal back into the fiber network at substantially low power levels.

It is known that scalar waves can travel over great distances and can be detected and translated at very low power levels. In addition, a scalar wave can penetrate walls and barriers much better than waves in Hertzian wave based systems. A new generation of applications and devices may thus become economically viable, whereas the devices of conventional systems that are operated via dedicated wireless networks are limited in range and are expensive. For example, the disclosed embodiments of the system permit any home or office to use the ground wire in any electrical outlet located in the home or office as a source of scalar transmission, and any tuned resonating circuit can detect and translate signals from a broadcast tower or other resonating device located half-way around the world. The disclosed embodiments of the system do not use the Hertzian spectrum (electromagnetic spectrum) but, rather, the ground potential is used as the transmission medium of electrostatic potential at a precisely tuned modulation and resonance. By modulating the transmitted signal at the resonance frequency, information can be transmitted and translated into digital data signals.

Moreover, the disclosed embodiments of the system enable hand held computers to access any web content or data application anywhere in the world without using frequencies operated by a local phone company. In many countries, such devices can operate on public frequencies or transmit below a certain power level mandated by the regulating authority of the specific country. In the United States, an FCC Part 15 compliance is required to transmit above a certain power level. In the preferred embodiments of the contemplated system, operation occurs in accordance with UWB (ultra-wideband) specifications, because scalar waves are transmitted instead of Hertzian waves.

Power transmission via wireless device has previously been attempted in a variety of ways using magnetic fields and pulsating systems. However, these systems possess a very low efficiency level and the effective range is typically limited to about ten (10) feet.

As demonstrated by U.S. Pat. No. 1,119,732 to Tesla, it is known for scalar systems utilizing high voltage and high frequencies to transmit high levels of power over great distances with minimal loss. In accordance with the disclosed embodiments of the contemplated system, implementation of managed power, billing authentication and safety measures permit the system to provide power to cars, boats, airplanes and trains and to homes and other stationary facilities. The contemplated embodiments of the system are also used to create a “super highway” of power generators which connect all of their power capacity in a single globally-extending network into a central generating, resonating signal from which clients can withdraw needed power, where the networks are configured to track who contributed power to the network as well as who has withdrawn power from the same network. This type of network advantageously provides a greater level of efficiency and reliability, because all generating facilities are allowed to share power with all other power capacities that are available around the globe over a 24 hours-a-day time period.

In accordance with the contemplated embodiments of the system, DC or AC power generated in one location is accepted, where it can be bought for a low price and can then tune itself to transmit power to a specific tower in a specific location. A customer or a network can then purchase the electrical energy at prices higher than the local price.

A network of towers is provided in the vicinity of each power production facility. The operator of the disclosed system can contract to buy capacity at specified prices, and then contract to sell to buyers at other facilities. An allocation of the acquired capacity is created for broadcasting and sharing among buyers on one or multiple frequencies, where a measurement is performed of the amounts of power consumed by each tower for billing purposes.

With reference to FIG. 1, the network delivers generated input power from voltage levels above 10 kV AC or DC and translates the normal 50-60 Hz AC frequency to be stepped up above 500 kV AC at 5 KHz or 500 kV DC, or higher. The network transmits the energy via scalar waves, which can be transported over a single connecting wire, a body of water, the Earth or the ionosphere (or a combination thereof) to remote towers which are tuned to the same resonating frequency and connected to the generating facility. The receiving coils are wound in a direction opposite to the direction that the coil(s) of the transmitter are wound to increase resonance and coupling with the transmitting towers.

A step down voltage switch and a frequency converter may be employed that ensure safety when connecting to the electrical potential, and that also accord with applicable laws that govern the local power grid. A web or network consisting of hundreds of contributing grids and consuming grids of such systems may thus exist and enable multiple systems to contribute or extract power from such wireless grid at any time. A combination of the above system may be used to transmit a substantial amount of electrical power to remote places which may not be connected to a grid or which have a high cost for the generation of electricity. For example, an operation mining Bauxite at a remote location in Russia or Australia may prefer to process the ore locally using power provided by the disclosed system of the contemplated embodiments instead of shipping the ore in bulk to Iceland for processing due, given the low cost of electrical power that can be provided by the contemplated system. The contemplated embodiments of the system are configured to transmit all necessary power via dual or single wire, a body of salt water and/or the Earth itself. Each contemplated embodiment provides its own advantages as explained with respect to other disclosed or combined embodiments of the system.

In another embodiment, towers within the same network use the Earth as the conducting electrostatic resonator and transmit both the power and signals between the towers. Here, each tower is connected to a fiber optic network and to other networks via routers which then modulate IP data signals via induction to the resonating circuits. The IP data signals are then extracted at the destination tower via a reverse process, and demodulated to the fiber network as IP signals in a destination country. Transmission in accordance with the contemplated embodiment is immune from fiber cuts or traffic congestions and is performed with a lower latency than the transmission provided in known networks. Direct connection is thus provided to remote places which may not have access to traditional high speed fiber optics.

In another embodiment, a single shielded wire is utilized as a wave guide to focus the scalar wave and minimize transmission and frequency interference with other systems or to ensure that an outside source cannot tune to the transfer of power or information. A system thus provided can be used to minimize electromagnetic field (EMF) interference. The system of the contemplated embodiment is also advantageously useful in regions of the world in which no transmission bandwidth is available.

FIG. 8 is a schematic block diagram of a receiver 130 which operates based on interference to communicate with a transmitter or other resonating elements in a network. The receiver of FIG. 8 a simplified receiver which relies solely on the interference effect to communicate with the transmitter or other resonating elements in the network. Here, the application uses a TCP/IP socket (not shown) which is then signaled over the resonating network as a set of 1 & 0 signals representing the receiver device “tapping” in and out of the resonant network. All other resonant “listening” devices in the network will immediately “sense” the change in electrostatic “pressure” and can immediately calculate which device is causing such interference and detect and translate its set of signals to a TCP/IP signal so that their resident applications can use the TCP/IP socket to maintain communications with the identified device.

A one-wire power transmission system is described in U.S. Pat. No. 1,119,732 to Tesla. In accordance with the disclosed embodiments of the system of the invention, the one-wire system described in Tesla is used to form part of a global, grid network of a high voltage, high frequency power distribution network which can distribute and manage power among large producers and many millions of large and small consumers. Here, producers are permitted to couple their production facilities to the global network and to add current and tension in the oscillating grid. Other consumers are permitted to couple their devices or load systems and absorb the tension and current from the power grid. Unlike conventional power transmission networks, which operate on a closed circuit, alternate current system and only connect one or two neighboring grids at a time, the disclosed system of the contemplated embodiments operates on an open circuit and single-wire configuration to which all other grids and loads are connected via induction or switching facilities.

The contemplated systems are configured to connect power, measure power, transport power, re-measure power and bill users for their consumption of the power, and to pay the originators of the power. Users that consume power during peak hours may become originators of power during off-peak hours. The system is configured to permit each producer to submit its available generating capacity and the prices that it plans to charge for its capacity. The network controls all operations and connected grids and customers to maintain an optimal balance among the producers and consumers. As the load increases, the system connects or enables the provision of power capacity from a subsequent set of producers and a corresponding set of consumers based on prices that the consumers previously agreed to pay. An order of activation is also available for all to see so that trading and forecasting can be performed by all parties to achieve the highest prices for the generation of electrical power.

In another embodiment, the network utilizes existing undersea copper wires and cables to transmit high levels of power and maintain a grid so that multiple continents and different geographic locations are interconnected, and so that consumers at these multiple continents and different geographic locations can buy and sell power to each other on the same global network.

In another embodiment, the system utilizes the Earth as the conductor and a system for interconnecting the multiple towers. Moreover, it is possible for the system to utilize different frequencies, power and designs based on the medium and form of transmission to most effectively utilize existing copper wires and cables without harming them or burning them out through overheating or disintegration. In a network defined by the interconnected towers, modules are provided which enable the complete operation of the grid and devices through traditional interconnection of grids via high voltage switches and sub-stations. Certain embodiments of the network are also provided with a transformer that comprises a flat Tesla coil, or “pancake coil”, and resonant coils which through induction obtain normal high voltage from power stations, and elevate it to 2 MV or more and increase the frequency from the normal 50 or 60 Hz to 5 KHz or more.

In accordance with the contemplated embodiments of the system of the invention, multiple coils, such as millions or billions of coils, are tuned to resonate on the same global signal. Each coil is configured to modulate with very low power any desired unique wave or combination of waves which can only be deciphered or detected by other devices or towers with knowledge of the resonant frequency combinations. Consequently, the system can simultaneously operatively communicate or transceive with multiple devices or systems so long the key to their resonant frequency combinations is known. It should be noted that the modulations do not interfere with each other and since all such devices are in resonance, all of them receive all signals at all times.

The contemplated embodiments of the system may be used to power aircraft, cars, ships and other mobile or transient machines, and to enable simultaneous control and communications. The contemplated systems are configured to permit high frequency power consumption using electrical pulse or multi-phase high frequency methodologies and devices that can provide power and operate on these power feeds. Alternatively, the system is configured to step down the power and to return the stepped down power to users and loads at the conventional 110/220 V and 50/60 Hz as necessary in each geography based on the number of windings and coil diameter configurations in a known manner. By measuring the propagation delay and signals from multiple towers, exact device positioning can be established which permits replacement of the need for orbiting satellites. Moreover, the contemplated embodiments of the system operate in any underground or shielded facility where satellite reception is impossible.

In a broad sense, the Earth is a giant ball of iron surrounded by a high efficiency insulator and the atmosphere; thus any electrostatic impact on this ball of iron will resonate inside and around the ball or the atmosphere in much the same way that a rock thrown into a perfectly round pond will create an infinite combination of ripples that bounce off the walls or edge of the pond. Tuning circuits to emit scalar waves instead of Hertzian waves further reduce the dissipation of energy because scalar waves do not lose power as a square of the distance in the same manner as do Hertzian waves. This, combined with circuits tuned to resonate with the Earth's natural resonance, e.g., 1204 Hz, will enable transmission to any point on the globe with less than a 1% loss factor. Any signal modulated onto such a scalar wave will have virtually no loss whatsoever.

Any transmission tower of the disclosed system that generates an electrical impulse on the Earth at the right frequency will create a scalar resonant vibration that will be minimal in some areas, and that will have a maximum effect in a specific central and anti-nodal region, where the waveform oscillates in cycle instead of canceling out. It is at this oscillatory cycle that a tuned scalar circuit can absorb the maximum level of power from the transmission tower. Consequently, it is possible to transmit energy that is directed or tuned to specific geographies or regions from any point on Earth. The effect can be tuned for scalar waves traveling on the surface of the Earth and for others traveling through the Earth and reflecting back as a propagating electrostatic wave. Unlike normal wire having a surface area that limits the tension and current that the wire can safely handle, the Earth is the planet's largest conducting wire and has almost no resistance to electrostatic transmission of charge. Another analogy is that the Earth's electrostatic behavior is similar to a giant balloon filled with water; any impression on the balloon will travel along its surface and through it in all directions. Based on its radius, certain waves will cancel out while others will return with double the original signal impressed upon the balloon. The Earth acts as a positively-charged giant ball; any electrostatic impression vibrates at speeds on the order of the speed of light in a vacuum through and on the Earth.

Unlike Hertzian waves which require a high wattage to travel reasonable distances and which may cause cancer and other abnormal conditions to living tissue, scalar waves are phenomena which naturally occur in many forms. For example, the neurons in the human brain discharge electrostatic pulses on a single wire via scalar waves. Every lightning strike generates a scalar wave, and if it impacts the Earth, it can be measured at any point around the globe. The disclosed embodiments of the system thus require a substantially lower level of power and provide for the transmission of power and data in a form that is much safer for humans and other life forms.

Thus, while there are shown, described and pointed out fundamental novel features of the invention as applied to preferred embodiments thereof, it will be understood that various omissions and substitutions and changes in the form and details of the methods and devices illustrated, and in their operation, may be made by those skilled in the art without departing from the spirit of the invention. Moreover, it should be recognized that method steps and structures shown and/or described in connection with any disclosed form or embodiment of the invention may be incorporated in any other disclosed or described or suggested form or embodiment as a general matter of design choice.

What is claimed is:

1. A system for efficient transmission of power and signals, comprising:
at least one transmitter node comprising a ground plate and a first coil elevated above the ground plate and comprising a first-direction winding to define with said ground plate a capacitance, said transmitter node being operable for inducing an oscillating electric wave at a resonant frequency between the first coil and ground plate; and
a receiver spaced from said transmitter node and comprising a second coil comprising an opposite-direction winding for receiving said oscillating electric wave at the resonant frequency for receiving power induced in said second coil by said oscillating electric wave.

2. The system of claim 1, further comprising a plurality of said transmitter nodes spaced apart across a geographical area.

3. The system of claim 1, wherein said transmitter node is further operable for impressing a signal on said induced oscillating electric wave.

4. The system of claim 3, wherein said second coil of the receiver is adapted for receiving the signal impressed on said oscillating electric wave.

5. The system of claim 1, wherein said ground plate comprises an electrically conductive plate disposed predeterminately below a ground surface of the Earth.

6. The system of claim 5, wherein said conductive plate is disposed at least about 60 feet below the ground surface of the Earth.

7. The system of claim 1, wherein said transmitter node is further operable for impressing a signal on said induced oscillating electric wave and said second coil of the receiver is adapted for receiving the signal impressed on said oscillating electric wave.

8. The system of claim 1, wherein the system is configured such that the oscillating electric wave is accessible by any receiver at a predefined wavelength of the oscillating electric wave and a charge energy of the oscillating electric wave is discharged with less than a specific signal loss.

9. The system of claim 8, wherein the predefined wavelength is a quarter wavelength of the oscillating electric wave and the specific signal loss is less than 5% of the signal.

10. The system of claim 2, wherein the receiver is configured for determining a location of the sensor from the received oscillating electric wave based on relative positions of the receiver from the plural transmitting nodes.

11. The system of claim 1, wherein the receiver comprises:
an AC/DC trip circuit;
a control system coupled to the AC/DC trip circuit;
measuring devices connected to the control system;
an AC filter; and
a convertor;
wherein the AC filter and convertor condition components of the received oscillating electric wave from a low frequency input voltage to high-frequency, high-voltage components.

12. The system of claim 1, wherein the receiver is configured to detect and optimize resonance levels, absorb an electrostatic charge from the received oscillating electric wave and convert the electrostatic charge to a lower power level. 25

13. The system of claim 1, wherein the first coil comprises a Tesla coil.

14. The system of claim 1, wherein the first coil is elevated at least about 100 feet above the ground plate.

15. The system of claim 1, wherein multiple receivers are configured to communicate with each other.

16. The system of claim 2, wherein each transmitter node is placed at a spaced apart location at which a quarter wave of the oscillating electric wave has a maximum peak so that a maximum energy level is received by the receiver.
